(19) United States
(12) Patent Application Publication
(10) Pub. No.: US 2017/0349463 A1
(43) Pub. Date: Dec. 7, 2017

(54) MOBILE DEVICE FOR BIOLOGICAL TREATMENT OF BIOREACTOR-TYPE WASTEWATER

(71) Applicant: BFG ENVIRONMENTAL TECHNOLOGIES, Illkirch-Graffenstaden (FR)

(72) Inventors: Paul PRADEAU, Strasbourg (FR); Van Ly TRAN, Ostwald (FR); Pierre FRANCOIS, Strasbourg (FR); Remy FRANCOIS, Obermodern (FR)

(21) Appl. No.: 15/539,345

(22) PCT Filed: Dec. 21, 2015
(86) PCT No.: PCT/FR15/53696

§ 371 Date: Jun. 23, 2017

(30) Foreign Application Priority Data
Dec. 23, 2014 (FR) 1463287

(51) Int. Cl. C02F 3/12; C02F 1/44; C02F 103/00

(52) U.S. Cl. CPC C02F 3/1273; C02F 1/44; C02F 2103/002; C02F 2203/008; C02F 2103/005

(57) ABSTRACT

A mobile device for biological treatment of bioreactor-type wastewater with a submerged membrane enabling treatment of greywater and blackwater has an inlet duct for effluent to be treated and an outlet duct for treated and filtered water connected to a permeate pump. The device includes a container, the interior volume of which has a parallelepiped appearance with two large vertical lateral sides, and a membrane filter having an assembly of parallel, planar filtration membranes also with a vertical appearance. The membranes are connected to a downstream collector collecting the filtered water and connected to the outlet duct. The permeate pump ensures a transmembrane flow less than the subcritical flow. At least one diffuser of fine air bubbles is located at the base of each column. Each diffuser is connected to a regulating solenoid valve and to pump, ensuring therein an airflow greater than or equal to 10 Nm³/h per diffuser.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a mobile device for the biological treatment of bioreactor-type wastewater with a submerged membrane enabling treatment of graywater and blackwater. It also relates to a system making it possible to recycle said wastewater, or optionally to discharge it into nature while guaranteeing environmental protection. This biological treatment is traditionally done using activated purifying sludge, living in a reservoir in which the effluents to be treated are supplied. These bacteria in fact consume the organic pollution, a membrane system next making it possible to perform the solid/liquid separation, the filtrate available downstream from the membrane(s) being sufficiently filtered to be discharged if applicable.

The device according to the invention is subject to very particular constraints, inasmuch as it must 1) be compact, i.e., have a small volume, 2) have considerable operating autonomy, in that it requires very few human interventions, and 3) be easy to transport in light of the required mobility.

### 2. Description of Related Art Including Information Disclosed Under 37 CFR 1.97 and 37 CFR 1.98

One of the anticipated potential uses is the treatment of wastewater in rolling stock such as railway vehicles, coming from train toilets. Multiple other applications are possible, in particular in the field of public toilets, portable toilets for events, as well as any other form of transportation, for example boats, RVs, or non-collective sanitation (NCS), highway rest stops, etc., one of the features of the invention being that the device is not connected to a sanitation grid.

It can therefore be mobile, as in the case of trains, and must guarantee efficient treatment of the pollution from effluents over the longest possible length of time, several weeks and ideally several months, with no human intervention. It is therefore necessary to master the bacteriological process and its various parameters consisting of the aeration-anoxia-anaerobia cycles, temperature, pH, as well as filtration and membrane clogging parameters, in order to ensure the life and growth of the biomass under the volume conditions imposed by the compactness requirement, so as to achieve autonomy in this respect.

The compactness is intended to allow simplified treatment during maintenance phases, which must typically be able to be done by a single operator, and no more than two. To that end, the device must have a volume, weight and configuration that allow handling by one or two people.

### BRIEF SUMMARY OF THE INVENTION

To address these issues, and others that will be described hereinafter, the device for treating bioreactor wastewater with a membrane according to the invention, which is traditionally provided with an inlet duct for effluents to be treated and an outlet duct for treated and filtered water connected to a permeate pump, is characterized in that it comprises a container, the interior volume of which is between 50 L and 300 L, and has a parallelepiped appearance with two large vertical lateral sides, forming a reservoir in which the concentration of bacteria varies between 3 g/L and 30 g/L, divided into N columns (23) delimited by N-1 intermediate vertical separation walls each provided with an upper passage and a lower passage between columns enabling circulation of effluent between the columns. A membrane filter including an assembly of parallel, planar filtration membranes also with a vertical appearance, presenting a membrane surface area of between 1 m² and 12 m², is also located in the upper part of one of said columns, the central column if N=3, under the upper passage(s), the membranes being connected to a downstream collector collecting the filtered water and connected to the outlet duct, the permeate pump ensuring a transmembrane flow less than the subcritical flow. At least one diffuser of fine air bubbles is located at the base of each column, each diffuser being connected to a regulating solenoid valve and to pumping means ensuring therein an airflow greater than or equal to 10 Nm3/h per diffuser.

The combination of these geometric and physicochemical characteristics ensures that the objectives of compactness and autonomy assigned to the inventive device are met. More specifically, in this volume, subject to the use of this geometric configuration and appropriate piloting, such an air flow rate enables optimal oxygenation of the biomass and the provision of a controlled and stable environment therefor. The development of these parameters results from research and tests having made it possible to achieve satisfactory values for all of the cited parameters, i.e., able to ensure a balance in the management of the existence and growth of the bacterial medium over the long term without compromising the dynamics of the hydraulic operation.

Thus, among the encountered problems, it should be noted that during filtration, the sludge tends to become deposited on the membrane surface, creating a biofilm. It is necessary to ensure that this does not become a compact “cake” that would then gradually and increasingly affect the filtration. The clogging that would result therefrom would substantially decrease the autonomy of the system. All of the technological choices made in the context of the invention ultimately result in mastering the filtration process, by measuring 1) the bacterial concentration, 2) the impact thereof on the membranes, and 3) the oxygen supply of said bacteria, by managing the hydraulic flow of the sludge in the reservoir, etc.

The clogging is in particular limited by the tangential flow aligned with the membranes as it results from the selected configuration, in which the membrane surfaces are positioned parallel to the hydraulic flow, and participate in making these flows laminar. The air flow rate emitted by the diffusers next makes it possible to ensure that the tangential speeds are sufficient in line with the membrane surfaces.

According to the invention, the direction and sense of the air flows emitted by the diffusers of fine air bubbles in their respective columns are identical, leading the diffusers of two adjacent columns to work in opposition relative to the circulation direction of the effluents, their air flow rates additionally being controlled independently.

In practice, this amounts to saying that the diffusers inject air in opposite directions in the sludge circulation loop(s), which makes it possible to have a system capable of organizing a circulation speed of the air making it possible to better control the oxygen transfer rate, in direct connection with the bacterial concentration. The filtration is obviously only done when the air diffusers are activated, failing which the membranes would quickly become dirty, instead of which the air injected by said diffusers limits membrane clogging, regular injections of large air bubbles further making it possible to “unclog” the membranes. It is, however, necessary to find an acceptable compromise between the need for the oxygen transfer, which advocates for a solution with a low movement speed of the effluents, and the mechanical needs of dynamic skimming of the membranes, which on the contrary advocates for a higher speed.

To ensure a transmembrane flow rate below the subcritical flow, guaranteeing the proportionality of this flow rate with the transmembrane pressure and consequently the mastery of the rheology of the hydraulic circuit, the membranes are positioned such that a same transverse distance e separates the membranes from one another on the one hand and the end membranes and a large side or at least one median partition on the other hand, the vertical sides of the membranes being situated in the immediate vicinity of the small sides of the reservoir. The idea is not to offer a preferred path for the flow of effluents, which must be able to collide with the membrane surfaces under the same conditions irrespective of the position of the membrane, which facilitates making the global flow between the membranes laminar and homogenous.

In practice, the upper and lower passages create pressure losses in the hydraulic circuit forming at least one loop inside the reservoir, and in particular make it possible to control the speed of the effluent flow therein, with the air flow rate coming from the diffusers helping to move the sludge in said hydraulic circuit(s). Turbulence can be created in these locations, which is beneficial in the lower part because it makes it possible to avoid dirtying of the many orifices of the diffusers, which in particular serve to calibrate the bubbles: the latter must not have overly large diameters, which would reduce the oxygen transfer capacity. At the same time, these pressure losses decrease the overall efficiency of the system due to energy losses, resulting in a fine calibration of the upper and lower passages. One of the guiding ideas in the design of the bioreactor, and which is found in each step of the design, is the constant concern for improving oxygen transfers, which are crucial to ensure the sustainability of the bacterial medium according to the desired objectives. In this respect, the size of the bubbles must be kept as small as possible in order to guarantee the largest possible specific exchange surface, which creates the best oxygen transfer rate. Furthermore, the speed of the bubbles being controlled by the diffusion device in opposition, the contact times between the biomass and the air bubbles are optimized.

The geometry of the reservoir, as well as the components present inside this reservoir, are designed and chosen so as to improve the hydrodynamics of the flows, which also makes it possible to optimize the homogenous oxygen transfer and to limit the clogging phenomena of the membrane and diffusers.

In practice, the membranes can be planar ultrafiltration membranes. The membrane surface used is close to the theoretical membrane surface calculated so that the permeation flow is lower than the subcritical flow, for example 15 LMH.

More specifically, they can be formed by rectangular planar plates with filtering outer walls and a hollow inner volume, fastened to one another near their corners by a system maintaining their separation distance e and including a device stretching each membrane.

They are oriented parallel across from a large side of the reservoir on the one hand, and the intermediate separation wall on the other hand, or between two intermediate walls in the configuration with three columns. The effluent flow circulating between the membranes, treated by the bacteria in the liquid environment oxygenated by the bubbles emitted by the diffusers situated at the bottom of the column, is substantially laminar. The filtration is consequently done tangentially, which makes the existence of the air flows essential, the latter assisting the circulation of the sludge in the columns along a direction substantially following their axis.

The plates are kept at a distance from one another in each corner by washers forming a spacer, a circular orifice formed in each corner of each membrane forming, with the circular central opening(s) of the washers, a channel in which a rotary shaft is inserted, the latter being provided, in said channel, with a cam. Depending on its position, the cam situated in each corner is called upon to stretch, in cooperation with the cams situated in the other three corners, all of the membrane plates at the same time.

More specifically, in the scenario of a reservoir with two columns, the shaft bearing the cam connects the two large sides of the reservoir, and its end situated in the column with no membranes is provided with a shock-absorbing stop. Said shaft further includes means for blocking the cam in the stretching position of each membrane.

These means for blocking the cam can for example consist of a nut placed on the shaft near the intermediate wall, on the column side without membranes. A notched collar protruding radially from said shaft near said wall, on the side of the column with membrane filter, is moved into contact with a notched crown or zone secured to said wall by tightening the nut toward and in contact with the partition.

A tool, which may be a simple rod able to be actuated from the outside, able to be inserted into an orifice transversely traversing the shaft, makes it possible to rotate the shaft so as to stretch the membrane plates.

The membranes are also connected to a central hub made up of spacers with a central orifice forming, with the coaxial openings having the same shape as the membranes, a discharge collector for the filtered liquid, with an appearance perpendicular to the membranes, closed off at its ends by flanges, one of which rests on a first end of the hub and the other of which rests on a face of the intermediate wall opposite that on which the hub rests. The two flanges are fastened to one another so as to compress the hub adjustably. These spacers, like the washers of the systems applied to the corners of the membrane plates, have a thickness e corresponding to the separating distance between membranes. It will be recalled that this distance is also that which is respected between the two end membranes and the walls that face them, so as not to favor any flow axis of the effluents to be treated, which would result in non-homogenous filtration, the coalescence of fine bubbles into large bubbles, non-homogenous circulation speeds of the sludge, and the creation of potential dead zones.

The aspiration duct for the filtered water is fastened to the flange resting against the intermediate wall and connected to the collector. The flanges are for example screwed by screws, the head of which rests on one of the flanges and which is screwed into the other flange, which makes it possible to adjust the compression of the assembly.

The wastewater inlet duct in fact emerges in the upper part of the reservoir, above the upper passage, and has an inner diameter smaller than 50 mm. In practice, the bioreactor is placed, in the hydraulic circuit, downstream from a device that prevents the passage of foreign objects that could damage the filtration membranes. The reservoir further includes an emptying duct that emerges in its lower part, the upper segment of which penetrates the reservoir through the top and has a diameter at least equal to 20 mm. The lower segment, located above the diffusers, includes a gradually flatter section with a rectangular outlet orifice having a surface area substantially equivalent to that of the upper segment. It must be possible to empty said reservoir in several minutes, which requires a certain section surface area for said duct. Due to the limited space in the lower part and to ensure a homogenous hydraulic flow, due in particular to the bulk of the diffusers, the section of the pipe must be adapted therein as mentioned above.

According to one possibility, the membranes are ultrafiltration membranes with a pore size of 0.04 μm or a molecular weight cutoff (MWCO) corresponding to a molecular weight of 150 kDa. They can be made from polyester sulfone PES.

Very generally, the invention is designed for reservoir volumes of about 50 to 300 liters: more specifically, a height comprised between 50 and 200 cm, for a thickness of 15 cm to 40 cm and a width approximately the same as that of the membranes (see below).

This volume is compatible with the constraints initially set out, namely the creation of a compact mobile product, with a high bacterial concentration and several months of autonomy.

### BRIEF DESCRIPTION OF THE SEVERAL VIEWS OF THE DRAWINGS

The invention will now be described in reference to the appended drawings.

FIG. 1 is a sectional schematic view of an illustration of a reservoir with two columns of the membrane bioreactor device.

FIG. 2 shows a perspective view of the various pieces of equipment said reservoir.

FIG. 3 is a schematic sectional view of the stretching system of the membranes and the collector.

FIG. 4 is a partial front elevation view of a membrane stretched using such systems.

FIG. 5 shows a schematic view of a reservoir configuration with three columns, shown very schematically.

### DETAILED DESCRIPTION OF THE INVENTION

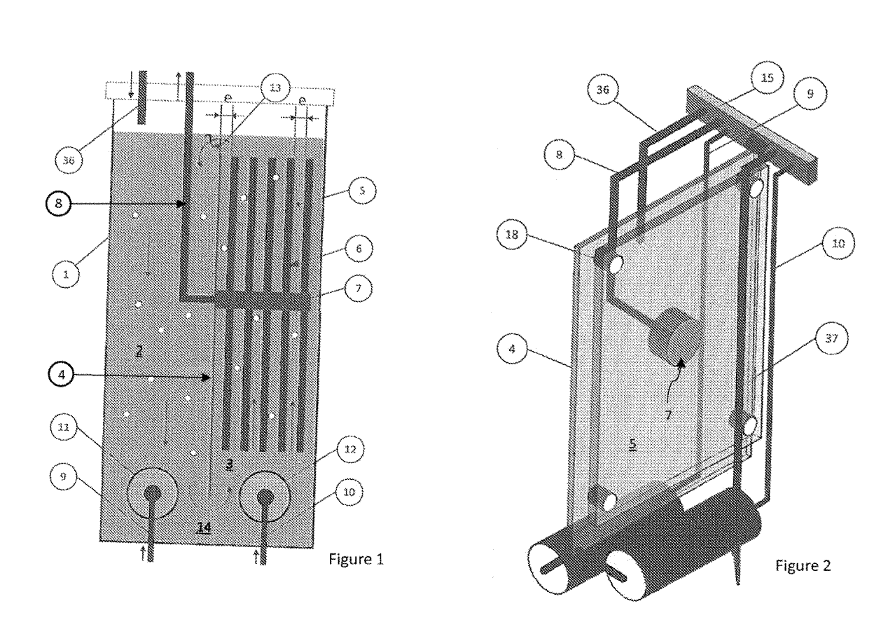

In reference to FIG. 1, the reservoir (1) is transversely divided into two columns (2) and (3) by an intermediate separating partition (4). The columns are laterally limited by the large walls of the reservoir (1), parallel to the partition (4). The column (2) contains the membrane filter (5), made up of a set of several parallel membranes (6) (in reality, thin plate membranes of about 3 mm) kept at the same distance e from one another. The two end membranes (6) are also at the same distance e from the outer wall of the reservoir (1) on the one hand and the intermediate separation wall (4) on the other hand. The membrane filter (5) comprises a collector (7) by which the water filtered by the membranes (6) is discharged via an orifice formed therein. This collector (7) is connected to an outlet duct (8) bringing the filtered water back into a hydraulic circuit to which the wastewater treatment device according to the invention belongs, for example a recycling loop for wastewater from toilets, upstream from the reservoir of the flushing system. To ensure correct discharge the filtered water, this duct (8) emerges in a permeate pump (not shown) that recirculates the filtered liquid for example toward said flushing system reservoir, or another posttreatment device, or toward the natural environment.

FIG. 1 also shows the pipes (9, 10) for supplying air for two diffusers (11, 12) situated in the bottom part of the columns (2, 3) of the reservoir (1), and connected upstream to pumps (not shown) as well as the wastewater inlet pipe (36). The upper (13) and lower (14) passages make it possible to ensure the circulation of the sludge in a loop inside the reservoir (1).

Aside from the equipment shown in FIG. 1, namely the diffusers (11) and (12) and their air supply ducts (9) and (10), the membrane filter (5) and its aspiration duct (8), and lastly the effluents inlet duct (36), the following elements, visible in FIG. 2, are also present in the reservoir: an emptying duct (37) and a plate (15) for the quick connections of the external pipes extending the various aforementioned ducts.

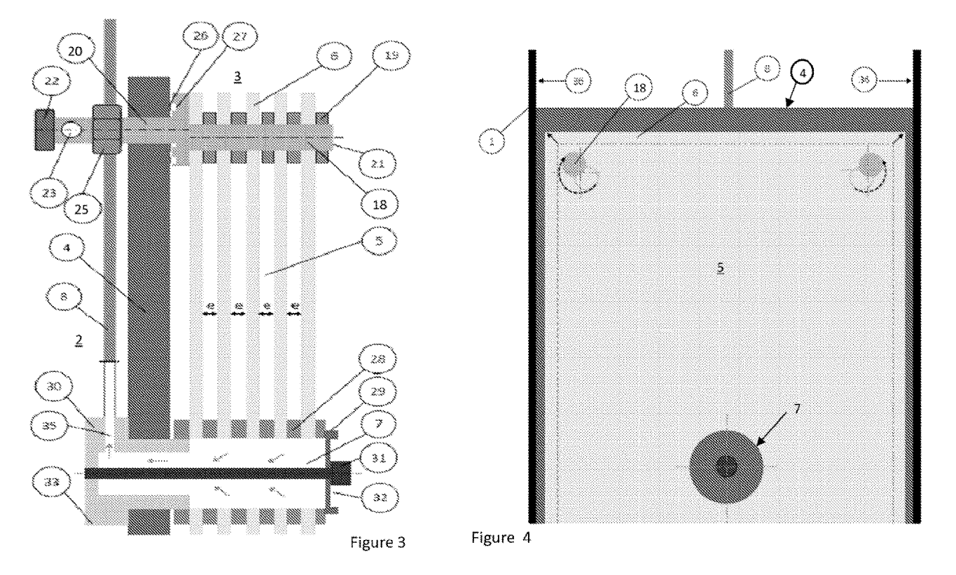

To ensure their correct operation, the membranes (6) of the membrane filter (5) can be stretched, in particular to preserve, between them at any location of their surface area, the same separation e, and therefore to ensure the most homogenous possible flow of the sludge, without favoring passages, but also without introducing pressure losses. The stretching device is situated at each corner of the membrane filter (5), and is based on a cam (18) (see in particular in FIG. 3).

More specifically, the membranes (6) are separated by washers (19) forming a spacer and surrounding a portion forming a cam (18) of a shaft (20) joining the large sides of the reservoir (1). Said cam portion (18) of the shaft (20) only needs to exist at the membranes (6), as in particular shown in FIGS. 3 and 4. In practice, the circular orifices that appear in each corner of each membrane (6) are coaxial to the circular openings of the washers (19), together creating a channel in which the rotary shaft (20), or more specifically its cam (18), can rotate. One of the ends of the shaft (20) includes a dog point (21) that bears on one of the walls or large sides of the reservoir (1) (not shown). The other end of the shaft (20) includes a shock absorbing stop (22) that rests against the upper wall of the reservoir (1). This stop (22) in particular serves to absorb the impacts and vibrations that could affect the reservoir, in particular when it is placed under real conditions in the rolling stock.

The shaft (20) further includes a transverse orifice (23) in which an elongate tool may be inserted to impart a rotation to the shaft (20) with the aim of stretching and blocking the membranes (6) of the membrane filter (5), as shown in FIG. 4 when the cam-forming portions (18) are separated from one another.

A nut (25) moves on the shaft (20) when it is tightened toward the intermediate wall (4), contributing to pressing a notched crown or zone (26) secured with the intermediate wall (4) against a notched collar (27) protruding radially from the shaft (20), and therefore blocking the assembly in the stretched position of the membranes (6), as shown by FIGS. 3 and 4. The membranes (6) of the membrane filter (5) are indeed stretched there, ready to be used.

The maintenance of the distance of the various membranes (6) using washers (19) situated in the four corners of the membrane filter (5) is repeated with a similar solution at the collector (7), as shown by FIG. 3. Indeed, in this location, the collector (7) is also made up of a series of spacers (28) of the washer type whereof the central orifice forms, with coaxial openings formed in the various membranes (6), a discharge collector (7) for the filtered liquid in the membrane plates (6) (symbolized by arrows). These spacers (28) have the same thickness as the washers (19), and they maintain, inside the membrane filter, the same spacing e between the adjacent membranes (6) as the corner washers (19). The filtered water flows in the collector (7) via edges of the openings formed in the membranes (6).

Two flanges (29, 30) obstruct the two ends of the collector (7), and are connected by a screw (31) resting in a recess (32) of the flange (29) while the threaded end is engaged in a threaded orifice (33) of the flange (30). The flange (30) has an aspiration duct (35) connected to the outlet pipe (8) conveying the filtered water toward the hydraulic circuit to which the bioreactor treatment device with membranes according to the invention belongs. In this specific usage scenario, the permeate pump that is positioned downstream (not shown) is capable of managing a flow rate of about 90 L/h. In reality, the device is sized to manage 15 to 20 L of wastewater per hour, corresponding to between 15 and 20 operations of a flushing system (about 0.45 L of water +0.3 L of urine containing fecal matter and dissolved toilet paper each time), and the pump is therefore largely dimensioned in this respect. In other usage scenarios, the volumes and dimensions of the components will be related to the quantity of waste water to be treated.

Emphasis has been placed several times on the positioning of the membranes (6) of the membrane filter (5) in the reactor (1) in order to avoid any favored paths of the sludge that would be detrimental to the overall filtration process. We will once again stress that, in the transverse dimension of the column, the same thickness e is preserved between all of the membranes (6) as well as between the membranes (6) and the outer wall of the reservoir (1) on the one hand, and the intermediate separation wall (4) on the other hand. In the width (not shown), i.e., on the lateral sides of the membranes (6), it is, however, also appropriate to ensure that the effluents cannot pass through a favored corridor. That is why said membranes (6) extend into the immediate vicinity of the small sides of the reservoir (1).

These membranes can have a surface area of up to about 6 m². According to one possibility, the wastewater supply duct (36), with an interior diameter of about 47 mm, in any case smaller than 50 mm, emerges in the upper part of the reservoir (1), preferably above the level of the sludge in order to produce a hydraulic break, avoiding any possibility of siphoning. The emptying pipe (37) emerges in the lower part and, to be equipped with a large enough section to allow quick emptying, its upper part has a diameter of about 22 mm or more, while its lower part, located at a diffuser and having less space, is flat with a rectangular outlet section for example of about 24 mm×9 mm.

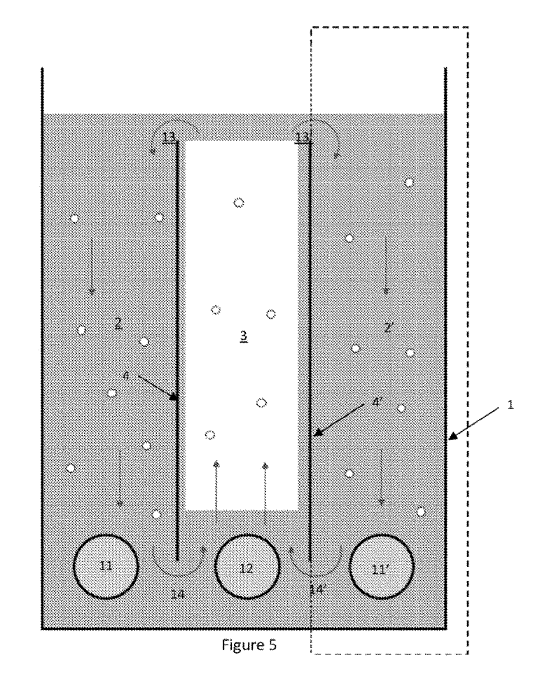

FIG. 5 very schematically shows a reservoir (1) with three adjacent columns (2, 2′, 3) separated by partitions (4, 4′), in which two wastewater circulation loops (symbolized by arrows showing the directions of the flows) cohabitate. Diffusers (11, 11′, 12) are placed at the bottom of the columns (2, 2′, 3), performing the same function as in the version with two columns. In such a configuration, the membrane filter (not shown) is placed in the upper part of the central column (3) shared by the two circulation loops. It works in exactly the same way as in the scenario with two columns, the circulation between columns (2, 2′, 3) being provided by upper (13, 13′) and lower (14, 14′) passages.

The illustrated configurations are not, however, exhaustive with respect to the invention, which on the contrary encompasses alternative embodiments in terms of shape, material and configuration that are within the reach of one skilled in the art.

1. A mobile device for the biological treatment of bioreactor-type wastewater with a submerged membrane enabling treatment of graywater and blackwater, the device comprising:
an inlet duct for effluents to be treated;
an outlet duct for treated and filtered water connected to a permeate pump;
a container, having an interior volume is between 50 L and 300 L and a parallelepiped appearance with two largo vertical lateral sides, said two vertical sides forming a reservoir, wherein said reservoir has a concentration of bacteria between 3 g/L and 30 g/L, divided into N columns (2≦N≦3) delimited by N−1 intermediate vertical separation walls, and wherein each intermediate vertical separation wall is provided with an upper passage and a lower passage between columns enabling circulation of effluent between the columns; and
a membrane filter having an assembly of parallel, planar filtration membranes with a vertical appearance, the filtration membranes presenting a membrane surface area of between 1 m² and 12 m², is said membrane filter being located in the upper part of one of said columns, wherein said membrane filter is located in a central column if N=3, under the upper passage, wherein the membranes connect to a downstream collector collecting the filtered water and connected to the outlet duct, wherein the permeate pump ensures a transmembrane flow less than the subcritical flow, and wherein at least one diffuser of air bubbles is located at the base of each column, each diffuser being connected to a regulating solenoid valve and to pumping means ensuring therein an airflow greater than or equal to 10 Nm3/h per diffuser.

2. The mobile device for the biological treatment of bioreactor-type wastewater with a submerged membrane, according to claim 1, wherein direction and sense of the air flows emitted by the diffusers of fine air bubbles in their respective columns are identical, leading the diffusers of two adjacent columns to work in opposition relative to the circulation direction of the effluents, their air flow rates additionally being controlled independently.

3. The mobile device for the biological treatment of bioreactor-type wastewater with a submerged membrane, according to claim 1, wherein a same transverse distance e separates the membranes from one another and the end membranes and a side or at least one median partition, the vertical sides of the membranes being situated in the immediate vicinity of the small sides of the reservoir.

4. The mobile device for the biological treatment of bioreactor-type wastewater with a submerged membrane, according to claim 1, wherein the membranes are planar ultrafiltration membranes, for example made from polyester sulfone.

5. The mobile device for the biological treatment of bioreactor-type wastewater with a submerged membrane, according to claim 1, wherein the membrane surface used is close to the theoretical membrane surface calculated so that the permeation flow is lower than the subcritical flow, for example 15 LMH.

6. The mobile device for the biological treatment of bioreactor-type wastewater with a submerged membrane, according to claim 1, wherein the membranes are formed by rectangular planar plates with filtering outer walls and a hollow inner volume, said membranes being fastened to one another near their corners by a system maintaining their separation distance e and including a device stretching each membrane.

7. The mobile device for the biological treatment of bioreactor-type wastewater with a submerged membrane, according to the claim 6, wherein the plates are kept at a distance from one another in each corner by washers forming a spacer, a circular orifice formed in each corner of each membrane forming, with the circular central opening of the washers, a channel in which a rotary shaft is inserted, the latter being provided, in said channel, with a cam.

8. The mobile device for the biological treatment of bioreactor-type wastewater with a submerged membrane, according to claim 7, wherein, when a reservoir has two columns, the shaft bearing the cam connects the two large sides of the reservoir, and its end situated in the column with no membranes is provided with a shock-absorbing stop, said shaft further including further comprising means for blocking the cam in the stretching position of each membrane.

9. The mobile device for the biological treatment of bioreactor-type wastewater with a submerged membrane, according to claim 8, wherein the means for blocking the cam comprises a nut placed on the shaft near the intermediate wall, on the column side without membranes, a notched collar protruding radially from said shaft near said wall, on the side of the column with membrane filter, being moved into contact with a notched crown or zone secured to said wall by tightening the nut toward and in contact with the partition.

10. The mobile device for the biological treatment of bioreactor-type wastewater with a submerged membrane, according to claim 1, wherein the membranes are connected to a central hub comprised of spacers with a central orifice forming, with coaxial openings having the same shape as the membranes, a discharge collector for the filtered liquid, with an appearance perpendicular to the membranes, closed off at its ends by flanges, one flange resting on a first end of the hub and the other flange resting on a face of the intermediate wall opposite that on which the hub rests, the two flanges being fastened to one another so as to compress the hub adjustably.

11. The mobile device for the biological treatment of bioreactor-type wastewater with a submerged membrane, according to claim 10, wherein the aspiration duct for the filtered water is fastened to the flange resting against the intermediate wall and connected to the collector.

12. The mobile device for the biological treatment of bioreactor-type wastewater with a submerged membrane, according to claim 10, wherein the flanges are screwed by a screw having a head resting on one of the flanges and which is screwed into the other flange.

13. The mobile device for the biological treatment of bioreactor-type wastewater with a submerged membrane, according to claim 1, wherein the wastewater inlet duct emerges in the upper part of the reservoir, above the upper passage, and has an inner diameter smaller than 50 mm.

14. The mobile device for the biological treatment of bioreactor-type wastewater with a submerged membrane, according to claim 1, further comprising:
an emptying duct emerging in the lower part of the reservoir, the upper segment of which penetrates the reservoir through the top and has a diameter at least equal to 20 mm, the lower segment, being located above the diffusers, and having a gradually flatter section with a rectangular outlet orifice having a surface area substantially equivalent to that of the upper segment.
